(19) United States
(12) Patent Application Publication
(10) Pub. No.: US 2006/0292543 A1
(43) Pub. Date: Dec. 28, 2006

(54) Scanning apparatus

(76) Inventors: James Marggraff, (US); Mark Flowers, (US)

Correspondence Address: WAGNER, MURABITO & HAO, LLP, TWO NORTH MARKET STREET, THIRD FLOOR, SAN JOSE, CA, 95113, US

(21) Appl. No.: 11/512,872

(22) Filed: Aug. 29, 2006

Related U.S. Application Data
(62) Division of application No. 10/803,806, filed on Mar. 17, 2004.
(60) Provisional application No. 60/456,053, filed on Mar. 18, 2003.

(51) Int. Cl. G09B 3/00

(52) U.S. Cl. 434/350; 434/307 R; 434/362

(57) ABSTRACT

A system including a scanning apparatus is disclosed. In one embodiment, the system has (a) an article having (i) a surface having a plurality of positions and a plurality of print elements respectively at the plurality of positions, and (ii) a plurality of codes respectively at the plurality of positions and relating to absolute or relative locations of the positions. The system also has (b) a scanning apparatus comprising (i) a stylus having an optical detector and an optical emitter, (ii) a processor coupled to the optical detector and the optical emitter, (iii) a memory unit comprising code for audio corresponding to the print elements, the memory unit coupled to the processor, and (iv) an audio output device coupled to the processor.

### RELATED U.S. PATENT APPLICATION

This Divisional Application claims the benefit of the co-pending, commonly-owned US Patent Application with Attorney Docket No. LF-163.01, Ser. No. 10/803,806, filed on Mar. 17, 2004, by Marggraff et al., and titled “Scanning Apparatus,” is incorporated herein by reference, which further claims priority to a U.S. Provisional Patent Application No. 60/456,053, filed on Mar. 18, 2003, and is incorporated herein by reference.

### BACKGROUND OF THE INVENTION

There are a number of systems that allow a user to obtain some feedback after selecting print elements on a print medium using a stylus.

One such system is described in Ohara et al. (U.S. Pat. No. 5,485,176). In this patent, a user uses a stylus and selects a print element in a book that is on a platform. The platform is connected to a video monitor. A visual output corresponding to the selected print element is displayed on the video monitor after the user selects the print element.

While the system described in Ohara et al. is useful, improvements could be made. For example, the platform uses a complicated page detection mechanism to determine which pages of the book are currently being displayed to the user. Furthermore, the system produces mainly visual outputs as opposed to audio outputs and has no writing capability. Also, the thickness of the book that is useable in the system is limited to the distance that the stylus and the electronics in the platform interact with each other. Therefore, very thick books cannot be used with the system.

Another system that allows a user to obtain feedback is called Scan-A-Page or Word from Brighteye Technology. To the extent understood, the system uses a scanning stylus and optical character recognition software run by a personal computer to recognize printed words. After a word is scanned and it is recognized, the recognized words are read aloud by a synthesized voice. While this system is also useful, its interactive capability is limited. For example, it is not suited to teach a user about a si4ect such as math, because writing is not interpreted by the system. To learn math effectively, a user must write. In addition, the Sean-A-Page or Word system is bulky as it requires a personal computer that is not readily transportable. In addition, this system cannot be us d with symbols and pictures that do not use characters such as letters and numbers.

Embodiments of the invention address these and other problems.

### SUMMARY OF THE INVENTION

Embodiments of the invention are directed to interactive systems, scanning apparatuses, and methods for scanning.

One embodiment of the invention is directed to an interactive system comprising: (a) an article comprising (i) a surface having a plurality of positions and a plurality of different print elements respectively at the plurality of positions, and (ii) a plurality of substantially invisible codes respectively at the plurality of positions and associated with the plurality of positions on the surface; and (b) a scanning apparatus comprising (i) a stylus having an optical detector and an optical emitter, (ii) a processor coupled to the optical detector and the optical emitter, (iii) a memory unit comprising code for different audio outputs corresponding to the different print elements and code for determining the locations of the plurality of positions, the memory unit coupled to the processor, and (iv) an audio output device coupled to the processor.

Another embodiment of the invention is directed to a scanning apparatus for use with an article comprising (i) a surface having a plurality of positions and a plurality of different print elements respectively at the plurality of positions, and (ii) a plurality of codes respectively at the plurality of positions and associated with the plurality of positions on the surface, the scanning apparatus comprising: (a) a stylus comprising an optical detector and an optical emitter; (b) a processor coupled to the optical detector and the optical emitter; (c) a memory unit comprising code for different audio outputs corresponding to the different print elements and code for correlating the locations of the plurality of positions with the audio outputs, the memory unit coupled to the processor; and (d) an audio output device coupled to the processor.

Another embodiment of the invention is directed to a scanning apparatus for use with an article comprising: (a) an optical detector and an optical emitter; (b) a processor coupled to the optical detector; (c) a memory unit comprising code for different audio outputs corresponding to the print elements, the memory unit coupled to the processor; and (d) an audio output device coupled to the processor.

Another embodiment of the invention is directed to a method for scanning, the method comprising: (a) providing an article comprising (i) a surface having a plurality of positions and a plurality of print elements respectively at the plurality of positions, and (ii) a plurality of codes respectively at the plurality of positions and relating to locations of the plurality of positions on the surface; (b) scanning a first code associated with a first print element with a scanning apparatus; (c) receiving a first audio output corresponding to the scanned first print element; (d) scanning a second code associated with a second print element with the scanning apparatus; and (e) receiving a second audio output corresponding to the scanned second print element, wherein the second audio output is different than the first audio output.

Another embodiment of the invention is directed to a method for scanning, the method comprising: (a) providing an article comprising (i) a surface having a plurality of positions, and (H) a plurality of codes respectively at the plurality of positions and relating to locations of the plurality of positions on the surface; (b) writing a print element on the article with a writing element in a scanning apparatus; (c) scanning a code associated with the written print element with the scanning apparatus; and (d) receiving an audio output corresponding to the scanned, written print element.

Another embodiment of the invention is directed to an interactive system comprising: (a) an article comprising (i) a surface having a plurality of positions, and (ii) a plurality of substantially invisible codes respectively at the plurality of positions and associated with the plurality of positions on the surface, wherein the substantially invisible codes are free of audio data; and (b) a scanning apparatus comprising (i) a stylus having an optical detector and an optical emitter, (ii) a processor coupled to the optical detector and the optical emitter, (Hi) a memory unit storing code for audio outputs and code for storing the locations of the plurality of positions, the memory unit coupled to the processor, and (iv) an audio output device coupled to the processor.

Another embodiment of the invention is directed to an interactive system comprising: (a) an article comprising (i) an object, and (ii) at least one sticker comprising a first substantially invisible code and a first print element, and a second substantially invisible code and a second print element, wherein the at least one sticker is on the object; and (b) a scanning apparatus comprising (i) a stylus having an optical detector and an optical emitter, (H) a processor coupled to the optical detector and the optical emitter, (iii) a memory unit coupled to the processor, wherein the memory comprises code for an output dependent on the scanning of the first substantially invisible code and the second substantially invisible code, and (iv) an audio output device coupled to the processor.

Another embodiment of the invention is directed to a method comprising: (a) providing an article including at least one sticker comprising a first substantially invisible code and a first print element and a second substantially invisible code and a second print element; (b) scanning the first substantially invisible first code; (c) scanning the second substantially invisible code; and (d) listening to audio relating to the first print element and the second print element.

These and other embodiments of the invention will be described in further detail below

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 shows a schematic drawing of a system that uses a two-dimensional article.

FIG. 2 shows a schematic thawing of a system that includes a two-dimensional article on a platform.

FIG. 3 shows a schematic drawing of a system that includes a three-dimensional article.

FIG. 4 shows a plan view of a printed sheet.

FIG. 5 shows a plan view of a printed sheet with a division scaffold.

FIG. 6 shows a page with print elements that would teach a user about music.

FIG. 7 shows an embodiment using stickers.

FIG. 8 shows a coupon including a number of blocks in which the user can write.

FIG. 9 shows a block diagram of some electronic components that can be used in the scanning apparatus.

FIG. 10 shows a block diagram of a system that can be used to deliver content to a scanning apparatus according to an embodiment of the invention.

### DETAILED DESCRIPTION OF THE INVENTION

One embodiment of the invention is directed to an interactive system. The interactive system includes an article having a surface having a plurality of positions and a plurality of print elements respectively at the plurality of positions. Different codes are respectively at the plurality of positions and may relate to the locations (e.g., the relative or absolute spatial coordinates) of the plurality of positions on the surface. The system also includes a scanning apparatus having (i) a stylus having an optical detector and an optical emitter, (ii) a processor coupled to the optical detector and the optical emitter, (iii) a memory unit comprising code for different audio outputs corresponding to the print elements, where the memory unit is coupled to the processor, and (iv) an audio output device coupled to the processor.

Illustratively, the article can be a page in a book. The page in the book can have substantially invisible codes on them. The codes are “substantially invisible” to the eye of the user, and these codes correspond to print elements such as letters, numbers, and pictures, on the page or correspond to the absolute or relative locations of the print elements on the page. “Substantially invisible” also includes codes that are completely or slightly invisible to the user's eye during normal use even though the printing (e.g., printed dots) making up the codes might be seen by the user. For example, in a dot pattern, differences in dot size are not easily discernable to the user, even though the dots themselves can be seen. If codes that are slightly invisible to the eye of a user are printed all over a sheet of paper, the sheet may appear to have a light grey shade if dot patterns printed in black ink are used. After the user scans the codes with the scanning apparatus, an audio output device in the scanning apparatus produces unique audio outputs (as opposed to indiscriminate audio outputs like beeping sounds) corresponding to letters, numbers, words, and pictures that are associated with the codes.

The user can use the stylus of the scanning apparatus in other ways. For example, the user can drag the stylus across letters to assemble phonemes into words, use it to trace mazes, or use it to play games. Additional examples are provided below.

Data can be provided to the scanning apparatus in any suitable manner. For example, the scanning apparatus may be designed with a flash memory for downloading new of different data, and/or it may be designed to accept transferable data storage devices such as memory cartridges (e.g., flash memory cartridges, ROM cartridges, etc.), memory sticks, and/or memory disks. In other embodiments, data could also be provided to the scanning apparatus through a wireless link such as an IR (infrared) or RF (radio frequency) link. The scanning apparatus can also contain a transceiver for wireless connectivity to obtain/upload content in real-time, or in batch-mode at off-hours. The scanning apparatus can be connected to one or more external computers in a direct-link-to-real-time-computing environment such as through a USB (universal serial bus) port in a computer.

Various input and output devices may also be included in the scanning apparatus. For instance, the scanning apparatus can include an audio output device such as an earphone or headphone jack, or speaker. The scanning apparatus can also have a visual output device. For example, the scanning apparatus can include a small, integrated display device such as an LCD (liquid crystal display) to provide supplementary visual information for the user.

The scanning-apparatus can also include a microphone so that the scanning apparatus can have record/playback capability. In a record/playback embodiment, a user can create a print element such as a word using the scanning apparatus (in those embodiments where it includes a writing instrument), and a user can dictate a message. The scanning apparatus can “remember” the location of the written word, and can also correlate the recorded speech to the location, thereby correlating the recorded speech to the word. In another example, a user may scan a pre-made print element such as a printed picture at a particular location on a sheet of paper and may record a message when scanning that the substantially invisible code associated with that picture. During a playback mode, the user can re-scan the picture and consequently the code associated with the picture, thereby triggering the previously recorded audio that was associated with the picture. Thus, in embodiments of the invention, the memory in the scanning apparatus may store code for audio derived from the user or derived from an external source such as a publisher.

The scanning apparatus can have alternative forms. In one embodiment, the scanning apparatus is shaped as a stylus and is preferably pocket-sized. If the scanning apparatus is in the form of a portable stylus, the scanning apparatus can weigh about 4 ounces, can have a battery life of about 40 hours, and can use a processor (e.g., an ASIC chip) to control the functions of the scanning apparatus. In other variations of this embodiment, the scanning apparatus takes the form of a pen that is ergonomically designed to rest comfortably in a user's hand. The stylus may contain an earphone jack, a data port, flash memory, batteries, and an optical scanner (with an optical detector and an optical emitter) at the stylus tip, and an optional speaker. The stylus can resemble a pen at its lower half, and can flow broader at the top to rest comfortably between the user's thumb and forefinger.

The scanning apparatus may also use absolute and/or relative positional sensing technology, single character handwriting recognition, audio such as synthesized speech, voice, music, and sound effects, writing capability, upgradeable memory storage, and an appropriate software operating system. Computer code for these and any of the functions performed by the scanning apparatus can be stored in the memory unit of the scanning apparatus.

In preferred embodiments, the electronics in the scanning apparatus determine the absolute or relative location of a stylus on a page, or any flat or three-dimensional surface. For example, the scanning apparatus can determine the absolute or relative location of the stylus on an arbitrary sized piece of paper (or other article). The piece of paper (or other article) can be printed with substantially invisible codes to enable location detection. In some embodiments, the scanning apparatus can be activated when it comes within a defined visual proximity of the targeted surface. The substantially invisible code that is scanned can also identify the document and page to the electronics in the scanning apparatus. Unlike the conventional interactive print media system described in Ohara et al., complicated page detection mechanisms are not needed in embodiments of the invention. The scanning apparatus automatically knows what page is being scanned and could even know what book is being scanned.

While books are described in detail in this application, other types of articles include note pads, filler paper, posters, placards, manus, stickers, tabs, product packaging, boxes, trading cards, magnets (e.g., refrigerator magnets) etc. If the article includes a sheet, the sheet can be of any suitable size and can be made of any suitable material. If a three-dimensional surface is used, the three-dimensional surface may include a molded figure of a human body, animals (e.g., dinosaurs), vehicles, characters, or other figures.

In preferred embodiments, the stylus of the scanning apparatus operates with content printed with virtually invisible dot patterns on a sheet (or other article). Substantially invisible codes (e.g., as in a binary coding scheme) are provided by the different patterns, and these substantially invisible codes may be related to the different positions on the sheet. As will be illustrated in detail below, by using codes that directly or indirectly relate to absolute or relative positions, embodiments of the invention can be used to learn about subjects such as math where the location information of numbers is needed to perform mathematical calculations. This is compared with simply using ordinary conventional printed bar codes, which encode unique data that do not relate to the locations of those bar codes.

The substantially invisible codes may directly or indirectly relate to the locations of the plurality of positions and/or any print elements on the sheet. In some embodiments, the substantially invisible codes can directly relate to the locations of the plurality of positions on a sheet (or other article). In these embodiments, the locations of the different positions on the sheet may be provided by the codes themselves. For example, a first code at a first position may include code for the spatial coordinates (e.g., a particular x-y position) for the first position on the sheet, while a second code at a second position may code for the spatial coordinates of the second position on the sheet. Different print elements can be at the different positions on the sheet. These print elements may be printed over or under the codes. For example, a first print element can be at the first position overlapping the first code and a second print element can be at the second position overlapping the second code. When a user scans, for example, the first code and the first print element at the first position, a processor in the scanning apparatus can determine the particular spatial coordinates of the first position, and can retrieve audio that corresponds to the first position and also the first print element at the first position.

In other embodiments, the substantially invisible codes can indirectly relate to the locations of the plurality of positions on a sheet (or other article). The substantially invisible codes may not explicitly identify particular locations on the sheet, but may include unique data. This unique data is translated into relative or absolute location information in the scanning apparatus. For example, a first code and a first print element may be at the top portion of a sheet, while a second code and a second print element may be at a bottom portion of the sheet. The first substantially invisible code at the top portion of the sheet may identify a number such as “1234”, which does not explicitly identify the location of the first print element or the first code. The second substantially invisible code may identify a number such as “5678”, which does not explicitly identify the location of the second print element or the second code. In these embodiments, the relative or absolute location information may be stored in the memory unit of the scanning apparatus. Accordingly, when the code “1234” is scanned, the processor in the scanning apparatus uses a lookup table to look up the code “1234” and subsequently determines that the first print element has been selected and that it is at the top portion of the sheet. In these embodiments, the location information for the print elements may be stored in the memory unit of the scanning apparatus rather than on the sheet.

Regardless of where the location information is stored, in embodiments of the invention, the processor in the scanning apparatus determines the absolute or relative location of the codes and the print elements that are associated with the codes. The scanning apparatus may also include a mechanism that maps or correlates relative or absolute locations with audio segments in the memory unit. As noted above, the mechanism can be a lookup table that correlates specific audio outputs in memory to particular locations on an article, and this lookup table can be stored in the memory unit.

Preferably, the substantially invisible codes are embodied by dot patterns. Technologies that read visible or “subliminally” printed dot patterns exist. These printed dot patterns are substantially invisible to the eye of the user so that the codes that are present in the dot patterns are undetectable by the user's eyes in normal use (unlike normal bar codes). The dot patterns can be embodied by, for example, specific combinations of small and large dots that can represent ones and zeros as in a binary coding. The dot patterns can be printed with ink that is different than the ink that is used to print the print elements, so that the dot patterns can be specifically read by the scanning apparatus. Specific combinations of dots can be printed at different positions on an article to either indicate the coordinates of that position or indicate the specific print element at that position to the scanning apparatus. Anoto, a Swedish company, employs a technology that uses an algorithm to generate pattern the enables a very large unique data space for non-conflicting use across a large set of documents. Their pattern if filly printed would cover 70 trillion 8.5″×11″ pages with unique recognition of any 2 cm square on any page. Paper containing the specific dot patterns is commercially available from Anoto. The following patents and patent applications are assigned to Anoto and describe this basic technology and are all herein incorporated by reference in their entirety for all purposes: U.S. Pat. No. 6,502,756, U.S. Application Ser. No. 10/179,966, filed on Jun. 26, 2002, WO 01/95559, WO 01/71473, WO 01/75723, WO 01/26032, WO 01/75780, WO 01/01670, WO 01/75773, WO 01/71475, WO 00/73983, and WO 01/16691.

In some embodiments, the dot patterns may be free of other types of data such as data representing markers for data blocks, audio data, and/or error detection data. As noted above, the processor in the scanning apparatus can determine the location of the stylus using a lookup table, and audio can be retrieved and played based on the location information. This has advantages. For example, compared to paper that has data for markers, audio, and error detection printed on it, embodiments of the invention need fewer dots, since data for markers, audio, and error detection need not be printed on the paper. By omitting, for example, audio data from a piece of paper, more space on the paper can be rendered interactive, since actual audio data need not occupy space on the paper. In addition, since computer code for audio is stored in the scanning apparatus in embodiments of the invention, it is less likely that the audio that is produced will be corrupted or altered by, for example, a crinkle or tear in the sheet of paper.

Although dot patterned codes are specifically described herein, other types of substantially invisible codes may be used in other embodiments of the invention. For example, infrared bar codes could be used if the bar codes are disposed in an array on an article. Illustratively, a sheet of paper may include a 100×100 array of substantially invisible bar codes, each code associated with a different x-y position on the sheet of paper. The relative or absolute locations of the bar codes in the array may be stored in the memory unit in the scanning apparatus.

The scanning apparatus may work with any other types of articles, in addition to sheets with substantially invisible dot patterns. For example, the scanning apparatus can work with any suitable paper media (e.g., any book or paper, any thickness, any size, any binding). The scanning apparatus can work with any bundling, any posting, any packaging, etc. It also works with printed three-dimensional surfaces, and plastic pieces, which can be printed or labeled. For example, print elements such as words or symbols may be printed on a three-dimensional body such as a globe or a model of the human body. These words or symbols can be selected to produce audio outputs that correspond to those-words and symbols.

The print elements on the article may teach the user about any suitable subject. For example, the print elements may teach according to a specific pedagogy. Subjects to be taught include math, spelling, reading, writing, history, geography, social studies, fun facts, vocabulary, phonics, letter recognition, etc.

The print elements at the plurality of positions on the article may be pre-printed print elements or may include non-user (e.g., a manufacturer or a publisher) created markings that are directly printed on the article. Print elements could alternatively be markings on labels or stickers that are stuck to an object.

The print elements may include user created markings. For example, a print element can include a number that is written down on a sheet of paper by a user.

Illustratively, a user may write print elements using a writing instrument in the stylus. For example, the user may write down numbers on a sheet of paper. The scanning apparatus uses handwriting recognition software to recognize what the user has written, and determines the locations of these written print elements. The scanning apparatus then correlates the print elements the user has written on the sheet to their locations on the sheet. If the user scans those user-generated print elements at a later time, the scanning apparatus produces audio outputs that can correspond to those written print elements. For example, the user may write down the number “7” on the sheet using a writing element in the scanning apparatus. The number “7” may be over a substantially invisible code associated with a particular x-y location on the sheet. As the user writes, the scanning apparatus determines that the user has written down the number 7 at the location of the position, and records this in memory. If the user selects the written number 7 at a later time, the scanning apparatus again scans the code, determines the particular location scanned, and determines that the user has scanned the number 7 at that position. The scanning apparatus may then provide some audio output associated with the number 7, such as “you wrote the number 7.” As will be explained below, such embodiments can be used to effectively teach a user a complex subject such as math, since the scanning apparatus can recognize the written print element and can remember its absolute or relative location on the sheet.

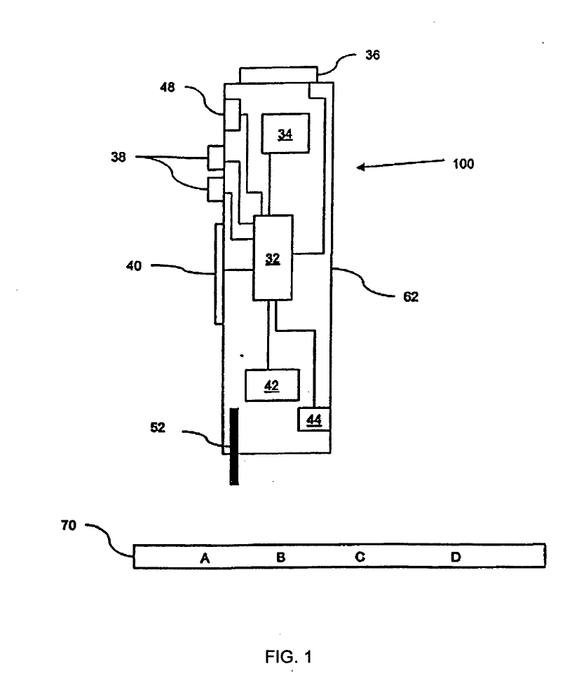

As described in further detail below, the scanning apparatus may have different configurations. In some embodiments, the scanning apparatus comprises a stylus and a platform (which may resemble a clipboard). The stylus is tethered to the platform and may contain a speaker, batteries, and flash/cartridge connector. The platform can clip to a sheet for convenience. In preferred embodiments, the scanning apparatus can be embodied by a self-contained stylus. Schematic illustrations of examples of such embodiments are in FIGS. 1-3.

FIG. 1 shows a system according to an embodiment of the invention. The system includes a scanning apparatus 100 and an article 70. The scanning apparatus 100 is in the form of a stylus.

The scanning apparatus 100 includes a processor 32 inside of a housing 62. The scanning apparatus 100 also includes an audio output device 36 and a display device 40 coupled to the processor 32. The audio output device 36 could be a speaker or an audio jack (an earphone or headphone jack). The display device 40 could be an LCD (liquid crystal display). Other suitable components include a device for providing tactile feedback (not shown).

Input buttons 38 are also present and are electrically coupled to the processor 32 to allow a user to input information into the apparatus 100. A power source 34 such as a battery is in the housing 62 and supplies electricity to the processor 32 and other components of the scanning apparatus 100.

An optical emitter 44 and an optical detector 42 are at one end of the stylus-shaped scanning apparatus 100. The optical emitter 44 and the optical detector 42 are coupled to the processor 32. The optical emitter 44 may be, for example, an LED (light emitting diode) or other light source, while the optical detector 42 may comprise, for example, a charge coupled device.

The processor 32 may include any suitable electronics to implement the functions of the scanning apparatus 32. For example, the processor 32 may include a microprocessor with speech synthesizing circuitry for producing synthesized speech, amplifier circuits for amplifying the speech, circuitry for controlling any inputs to the scanning apparatus 100 and any outputs provided by the scanning apparatus 100, as well as an analog-to-digital converter to convert signals received from the optical detector 42 into digital signals.

A memory unit 48 is also present in the scanning apparatus 100. The memory unit 48 is coupled to the processor 32. The memory unit 48 may be a removable memory device such as a ROM or flash memory cartridge. In other embodiments, the memory unit 48 may comprise one or more memory devices (e.g., RAM, RAM, EEPROM, etc.) that are completely internal to the housing 62. Semiconductor-based memory devices can be used.

The memory unit 48 comprises computer code for performing any of the functions of the scanning apparatus 100. For example, the memory unit 48 may comprise code for recognizing printed characters, code for recognizing a user's handwriting and interpreting the user's handwriting (e.g., handwriting character recognition software), code for correlating positions on an article with respective print elements, etc. The memory unit 48 may also comprise code for audio and visual outputs. For example, code for sound effects, code for saying words, code for lesson plans and instruction, code for questions, etc. may all be stored in the memory unit 48. Code for audio outputs such as these may be stored in a non-volatile memory (in a permanent or semi-permanent manner so that the data is retained even if the scanning apparatus is turned off), rather than on the article itself.

Other scanning apparatus embodiments may include a music player such as an MP3 player. In general, it is possible for the scanning apparatus to include the ability to store and play music that is loaded from an external source.

A writing element 52 is at the same end of the stylus-shaped scanning apparatus 100 as the optical emitter 44 and the optical detector 42. The writing element 52 may comprise a pen or pencil and may or may not be retractable. A user can hold the stylus-shaped scanning apparatus 100 and write on a sheet with it. The user's writings may also be scanned using the optical emitter 44 and the optical detector 42 and the processor 32 may interpret the user's writing.

The article 70 is two-dimensional and may be, for example, a sheet of paper. The letters A, B, C, and D represent different positions on the article 70. The different positions A, B, C, and D on the article 70 can have different codes (not shown) and different print elements (not shown). The codes and the print elements may overlap at positions A, B, C, and D. The different codes are substantially invisible to the eye of the user, and a user is unable to see the codes with the user's eyes in normal use.

Illustratively, the user may scan the word CAT with the scanning apparatus.

The word CAT (now shown in FIG. 1) is printed at position A over a substantially invisible code at position A. As the user scans the word CAT, the optical emitter 44 produces a light signal which is reflected off of the substantially invisible code at position A and is received by the optical detector 42. The processor 32 determines the location of the position A and retrieves audio that corresponds to the word CAT from the memory unit 48. For example, the processor 32 may cause the audio output device 36 to produce the phrase “CAT is spelled C-A-T”.

In other embodiments, the writing element 52 can be used. As will be described in further detail below, the writing element 52 could be used to write on a specific location on the article 70. Using appropriate handwriting recognition and/or optical character recognition software (which may be stored as code in the memory unit 48), a user's writing can be interpreted by the processor 32 so that the processor 32 can determine what the user wrote and also the particular location of the position where the user is writing. As explained in further detail below, using this information, the system and the scanning apparatus can be adapted to teach a user about a complex subject such as math.

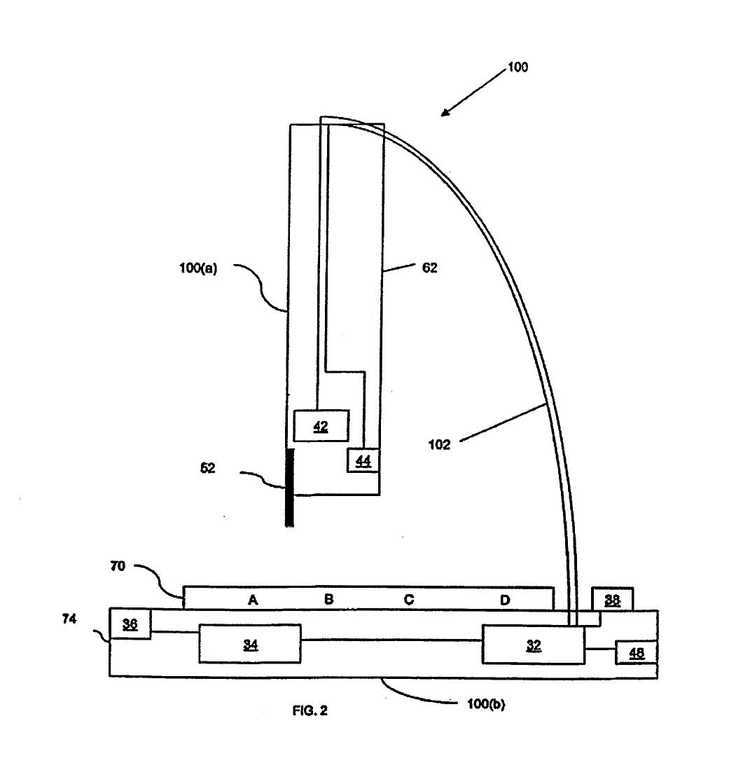

FIG. 2 shows another embodiment of the invention. In this example, like numerals designate like elements and the previous descriptions of like elements need not be repeated. However, in this embodiment, the scanning apparatus 100 includes a stylus 100(a) and a platform 100(b). A cable 102 couples the platform 100(b) to the stylus 100(a). The platform 100(b) supports the two-dimensional article 70. In this embodiment, the processor 32, the power source 34, the audio output device 36, buttons 38, and the memory unit 48 are in the platform 100(b) instead of the stylus 100(a). In other embodiments, it is possible to not have a cable and there can be a wireless link between the stylus 100(a) and the platform 100(b) (or other base unit).

In the embodiment shown in FIG. 2, there are fewer electronic components in the stylus 100(a), so that the stylus 100(a) can be made less bulky than the stylus-shaped scanning apparatus shown in FIG. 1. When the article being used is a sheet of paper, the sheet can be placed on the platform 100(b) to provide the sheet with support.

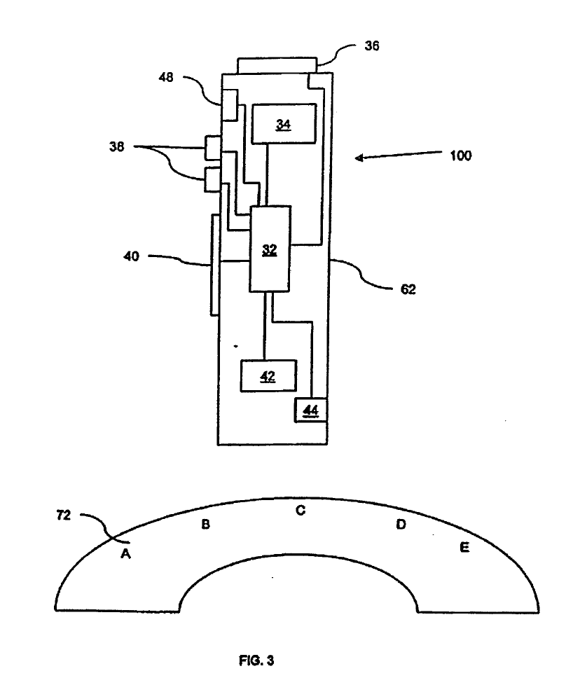

FIG. 3 shows another embodiment of the invention. In FIG. 3, like numerals designate like elements as in FIGS. 1 and 2. However, in this embodiment, the article 72 is three-dimensional, instead of two-dimensional. Also, in this example, the stylus-shaped scanning apparatus 100 does not have a writing element. As illustrated by this example, the article 72 could be a three-dimensional object such as a globe, molded plastic body, etc. Various codes that are substantially invisible to the eye of a user can be at the same positions as various print elements on the three-dimensional article 72. The print elements on the three-dimensional article 72 can be scanned and the scanning apparatus 100 can produce audio outputs corresponding to the print elements on the three-dimensional article 72.

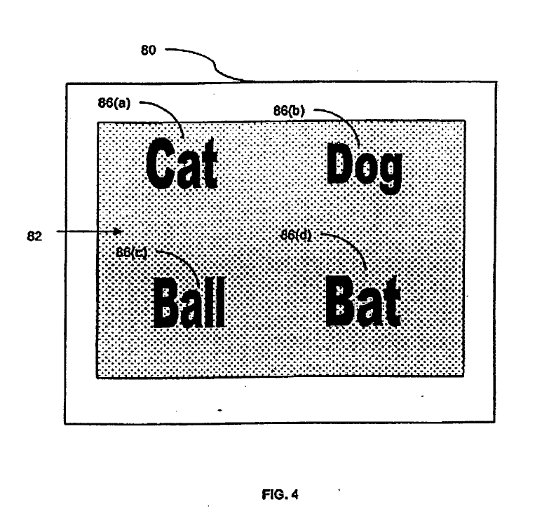

Embodiments of the invention can also be used to teach about language. FIG. 4 shows a plan view of a sheet of paper 80 with small dots 82. The dots 82 can be of different sizes and/or shapes to provide different codes (not shown) for the different positions on the sheet of paper 80. See, for example, the U.S. Patents and Applications noted above. The codes relate to specific locations or the specific spatial coordinates of the different positions. Words 86(a)-86(d) can be printed over (or under) the codes. For example, the words “cat”, “dog”, “ball” and “bat” can be printed over different codes. When a word such as “cat” is scanned, the substantially invisible code is scanned along with the word “cat”. The code identifies the spatial coordinates of the stylus and a processing in the scanning apparatus determines that the user has selected the word “cat”. Alternatively, the code is not related to the location of the code and the location information for the code is stored in the memory unit in the scanning apparatus. In either case, the scanning apparatus then produces audio corresponding to the word “cat”.

In addition to language, the scanning apparatus can also be used to teach math. Students of all ages struggle with math. Many students simply give up and declare they are poor math students. In a recent poll of 866 middle and junior-high school students (₅th to ₈th grade), the subject voted “least-favorite” was math. While reading is a primary life-skill for educational, personal, and professional advancement, many would argue that math is not as significant a primary skill. While the simple, essential low-tech vehicle for learning how to read is a “book”, the equally simple, essential, low-tech vehicles for learning math are a pencil and paper. Calculators, PCs, and other devices provide assistance with various forms of math, but the pencil and paper are the basic learning tools for all math students. Students must write to learn math, and students lean math through writing.

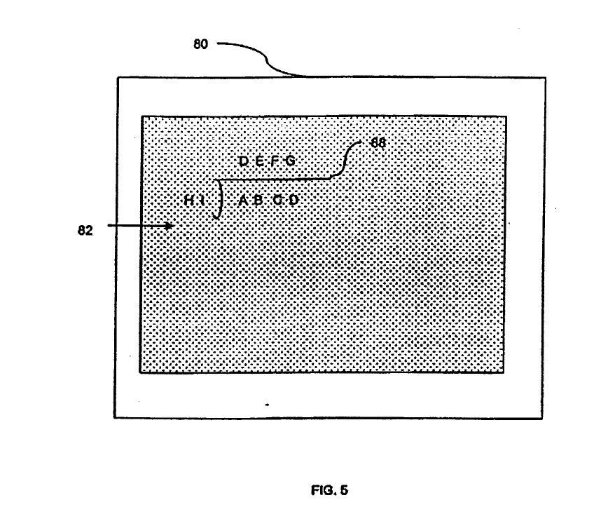

Illustratively, FIG. 5 shows a piece of paper 80 with a division scaffold 88 printed on the sheet of paper 80. As in the prior example, a dot pattern 82 directly or indirectly encodes the locations (e.g., the spatial coordinates) of the different positions on the sheet of paper 80. Different codes embodied by different patterns of dots are at the different positions A-I (A-I represent positions and would not be printed on the sheet of paper 80) as shown in FIG. 5. As shown by the examples below, the scanning apparatus may be used to teach a child a complex subject such as math (e.g., division, fractions, addition, subtraction, polynomial equations, multiplication).

As illustrated by the embodiment in FIG. 5, using embodiments of the invention, one can write the steps to homework problems once, on paper, while never setting down the writing instrument to fumble with another device such as a calculator. Using the system, a student may learn fractions, percentages, angles, areas, perimeters, geometry, trigonometry, and calculus.

Embodiments of the invention can be used to help a user learn about other subjects including chemistry, physics, history, and English, and may also include additional functions or software. Exemplary functions or software include a thesaurus, dictionary, spelling tutor, language translator, instant language translator and personal instructor. For example, in some embodiments, a user may see an item in a restaurant menu in Spanish, and write it on a pocket note pad, and hear the name of the food in English. A user may write a word in English, hear it in Spanish, and then hear it spelled. A user may write a word and then hear its definition. A user may write down the words on this week's spelling test, and then be quizzed on them. These applications are well suited for this medium because of the rapid “entry” of an item. Writing a word is faster than entering it into a PDA (personal digital assistant). Other applications include games and a musical composer.

As noted above, the scanning apparatus can have a writing element so that a user can write while scanning the user's writings, and while generating audio feedback. When the user writes, the user is:
1) initiating a non-real time communication to another person, who will read the writing at some other time;
2) initiating a non-real time dialogue with him/herself (for future reference, where the writing serves to augment short term memory limitations);
3) using symbols to facilitate immediate short term brainstorming, again using the paper as an enhancement to human memory limits;
4) using symbols to perform a procedural function than cannot be performed in his mind -again supplementing human memory limits; and
5) using symbols to stimulate some other brain function—such as depicting a three dimensional model than cannot be maintained/developed in his mind, or writing down a word to see if it “looks correct” when written (augmenting the process of conceptual spell checking).
   A complete natural extension of a user's “written” dialogue with the user is to respond to the symbols that are being written in a manner to assist, expedite, validate, or improve the dialogue. Additional examples that use writing are provided in the Examples section below.

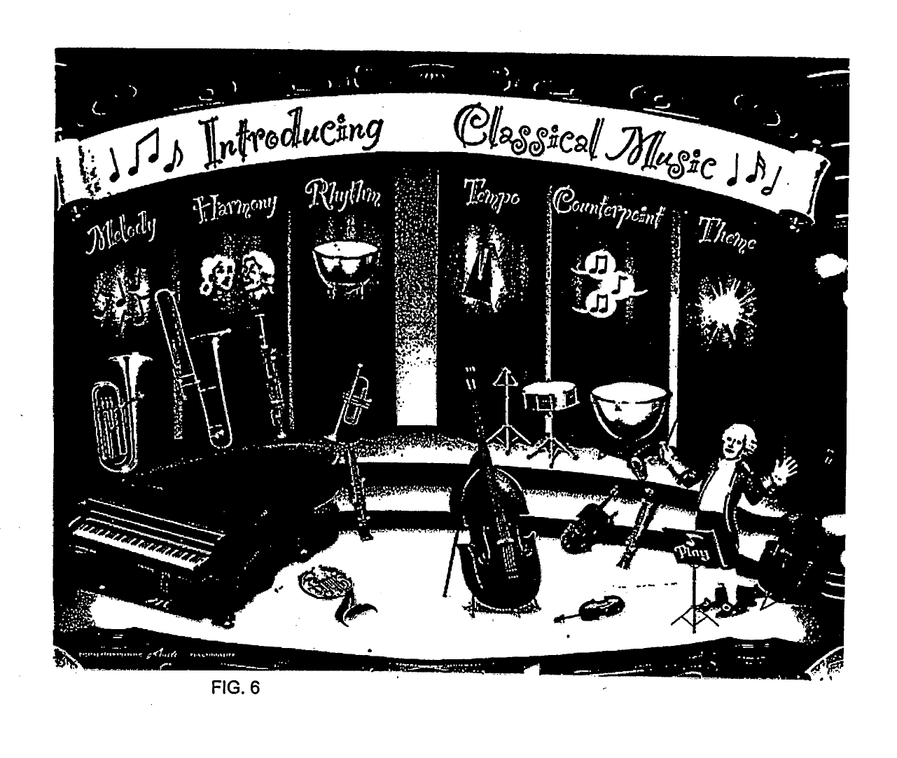

Embodiments of the invention can also be used to teach music. FIG. 6 shows another sheet according to an embodiment of the invention. As shown, the sheet has words such as melody, harmony, rhythm, tempo, counterpoint, and theme. Pictures of musical instruments are also on the sheet. A user can select any of the words or pictures using the scanning apparatus. After scanning a print element, the scanning apparatus produces an audio output that corresponds to the print element. For example, after selecting the picture of the trombone, the sound of a trombone can be produced using the scanning apparatus.

Embodiments of the invention can also use stickers. The stickers can include sheets with a peelable adhesive attached to a backing of some sort.

Stickers are particularly useful, since they can be placed on books, articles, dolls, and toys. By placing stickers on other objects, the objects can be rendered “interactive”. Illustratively, a doll may not have substantially invisible codes printed on its chest. A sticker or many stickers with the letters A-Z printed and substantially invisible codes corresponding to the letters A-Z may be placed on the chest of the doll. A user may then select the letter “B” using the scanning apparatus and can scan the substantially invisible code at that time. A processor in the scanning apparatus can recognize the substantially invisible code associated with the letter B, and can retrieve the appropriate audio code to cause the speaker to say “B says buh!”. Thus, in embodiments of the invention, stickers can be used to render non-interactive or partially interactive objects such as books, toys, and the like electronically interactive.

Thus, in some embodiments, a user can interact with two or more print elements on one or more stickers on an object (preferably two or more stickers) so that an output that is produced is dependent on the interaction with the two or more print elements. Accordingly, an interactive system according to an embodiment of the invention can comprise an article comprising an object, and one or more stickers comprising a first substantially invisible code and a first print element and a second substantially invisible code and a second print element. The system may further include a scanning apparatus comprising (i) a stylus having an optical detector and an optical emitter, (ii) a processor coupled to the optical detector and the optical emitter, (iii) a memory unit coupled to the processor, wherein the memory unit comprises code for an output dependent on the scanning of the first substantially invisible code and the second substantially invisible code, and (iv) an audio output device coupled to the processor. The scanning apparatus may include any of the features described in this application.

In these embodiments, the audio output that is produced by the scanning apparatus is dependent on the scanning of the codes associated with the print elements on the one or more stickers. For example, the output may be a calculation that is performed by two numbers on two stickers, or the output could be the sound of a three letter word after the user selects the three individual letters on three individual stickers making up the word. The output that is dependent upon the interaction with substantially invisible codes on one or more stickers may relate to games, calculations, sounds of words, etc.

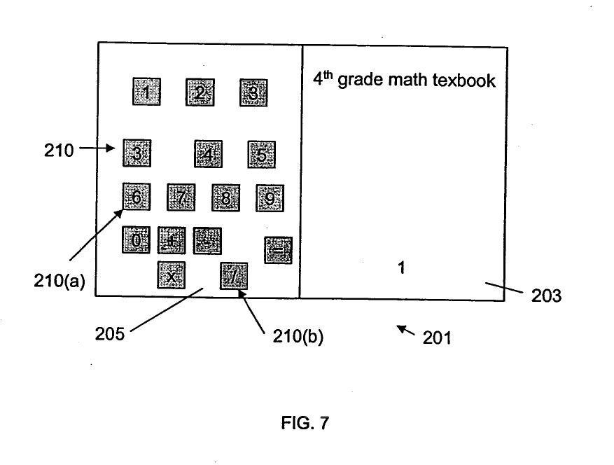

An embodiment using stickers is shown in FIG. 7. As shown in FIG. 7, a non-interactive object such as a book 201 may be obtained. A number of stickers 210 may be placed on the inside front cover 205 of the book so that a user-defined calculator is created. The stickers 210 include individual number stickers 210(a) and mathematical operator stickers 210(b). As shown by this example, each print element is on its own sticker. In other embodiments, all of the print elements shown could be on one sticker.

In an exemplary mode of operation, a user may use any of the previously described scanning apparatus embodiments to select a number such as the number “1” with the scanning apparatus and thereby scan a substantially invisible code on the sticker that is associated with that number. Then, the user may select the operator “+”, “6” and “=” in the same manner and then hear the synthesized voice say “7”. As described above, by using the substantially invisible codes, the scanning apparatus knows which numbers are selected by the user and can perform the mathematical operation that the user wants to perform. The software for performing the calculation “1+6=7” and for providing audio that corresponds to the calculation may be stored in the memory unit of the scanning apparatus. Other embodiments are also possible. For example, other embodiments may include user-defined keyboards or other user-defined user-interfaces. Although stickers with numbers are described in detail, stickers with letters, pictures, or symbols can be used.

As shown by these embodiments, it is possible to use stickers to modify non-interactive or partially-interactive objects to make them more interactive. Stickers can be used to form a functioning application (e.g., a calculator, a testing apparatus, a gaming apparatus), whereby an output that is produced by the scanning apparatus is dependent on the user's interaction with two or more stickers, codes, or print elements. The applications relating to the two or more stickers may relate to math, language, spelling, history, geography, etc. It is noted that in these applications, the substantially invisible codes that are used may or may not be related to the absolute or relative locations of the codes. For example, in these embodiments, it is possible to use substantially invisible bar codes that do not relate to location.

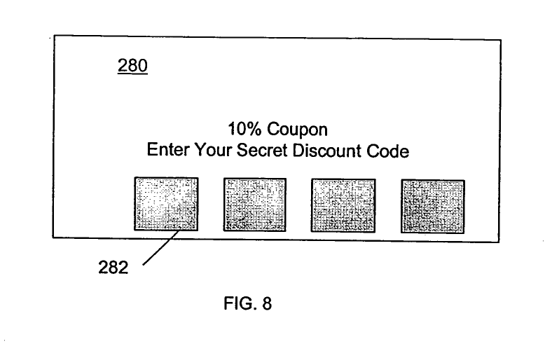

Although a number of educational and learning embodiments have been described, embodiments of the invention can also be used in a business context. The articles according to embodiments of the invention can include advertising circulars, invoices, mailings, etc. For example, an advertising circular may include a number of print elements corresponding to a game that is preprogrammed into the scanning apparatus. The user hears particular numbers after selecting particular pictures or words in the advertising circular (as a reward) during the game. As in other embodiments, substantially invisible codes may be present on the advertising circular so that a user can interact with the print elements on the advertising circular with the scanning apparatus. When the user obtains the numbers, the numbers may be written into the number blocks 282 on the coupon 280 shown in FIG. 8. The user may then take the coupon 280 to a cashier whereby the user will receive a discount thereafter. The coupon 280 may or may not have the substantially invisible codes described above.

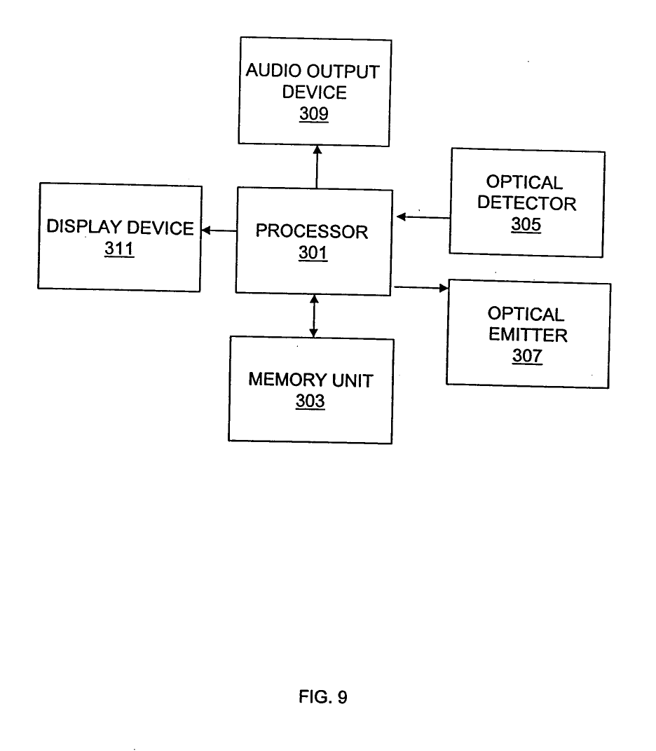

FIG. 9 shows a block diagram of some electrical components that can be used in a scanning apparatus according to an embodiment of the invention. The scanning apparatus may include a processor 301 and a memory unit 303 coupled to the processor 301. The processor 301 and the memory unit 303 may be embodied by one or more computer chips. In some embodiments, the processor 301 may include an application specific circuit, and a speech synthesizer may be associated with the processor 301. An optical detector 305 and an optical emitter are also operatively coupled to the processor 301. Output devices such as a display device 311 (e.g., an LCD or LED screen) and an audio output device 309 (e.g., a speaker or an earphone) may also be coupled to the processor 301. Additional exemplary details relating to these components are provided above and below.

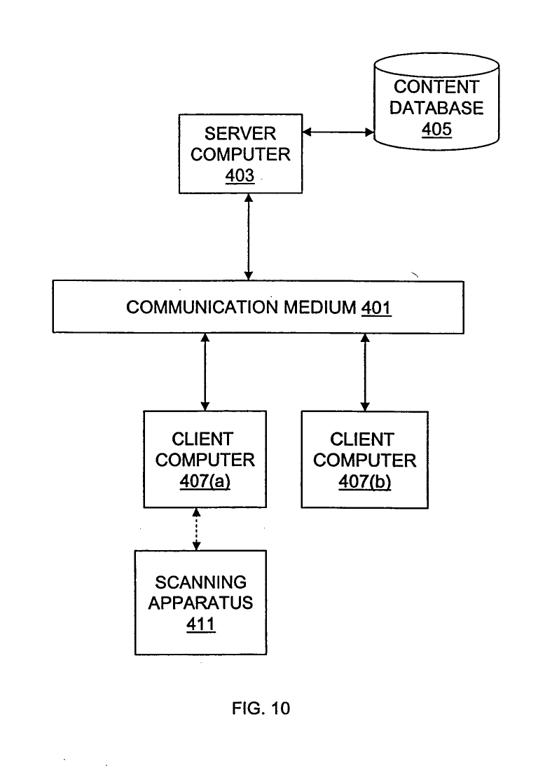

FIG. 10 shows a computer system that can be used to provide new and different content to the scanning apparatus. FIG. 10 shows a server computer 403 coupled to a database 405. The database 405 may store new content for the scanning apparatus 411. The new content may comprise code for audio outputs, code for visual outputs, code for operating systems, etc. Although database 405 and server computer 403 are shown as two blocks, it is understood that they may be embodied by a single computational apparatus or many computational apparatuses working together.

A communication medium 401 allows the server computer 403 and a plurality of client computers 407(a), 407(b). The client computers 407(a), 407(b) may be ordinary personal computers. The communication medium 401 may be any suitable communication network including the Internet or an intranet.

The scanning apparatus 411 may be any of the scanning apparatuses described herein. The scanning apparatus 411 may communication with the client computer 407(a) through any suitable connection including a wireless or wired connection. Through the client computer 407(a), the may be in continuous or discontinuous communication with the server computer 403 via the communication medium 401.

Additional specific embodiments and examples are described in further detail below.

### EXAMPLE 1

Johnny, age 9, stares at a long division homework problem and proceeds as follows using his scanning apparatus.
1) The division scaffold is printed on a sheet of paper (with substantially invisible codes as described above) as shown in FIG. 5 or could be written by Johnny. If the Johnny writes it, the scanning apparatus automatically determines that a scaffold has been drawn and records the location of the scaffold.
   √
2) He writes the divisor, 18, and the dividend, 8796 into the scaffold:
   18\sqrt{8796}
3) His scanning apparatus scans these numbers as Johnny writes. The scanning apparatus determines that Johnny has written the numbers “18” and “8796” and knows the locations of the numbers “18” and “8796” on the sheet. The scanning apparatus can then determine the numbers that are needed to complete the answer to the long-division problem, and knows where those numbers will be located, relative to the positions of the numbers “18” and “8796”, and relative to the position of the division scaffold. The scanning apparatus may then help Johnny, step-by-step through the math process. For example, the scanning apparatus then announces:
“Let's divide 18 into 8776. For help, scan the division sign.”
4) Johnny needs help. He scans the division scaffold, and the scanning apparatus prompts Johnny:
“How many times does 18 go into 87. Write the answer above the 7 in 87.”
5) Johnny isn't sure. He thinks the answer is 4. So he writes 4 above the 7, and then scans it. He hears a correct answer sound effects followed by “4”, and realizes he's got the right number. 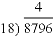
6) Johnny remembers that he's supposed to multiply 4 by 18. He knows that 4 times 8 is 32, and writes a 2 beneath the 9: 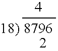
7) The scanning apparatus knows that Johnny has written the correct number in the wrong column and provides a gentle, wrong-answer sound effect.
Johnny isn't sure what he's done wrong, so he scans the 2. He hears:

“The 2 should be written under the 7 and 87.”
8) Johnny realizes the mistake he's made and erases the 2. He rewrites the 2 beneath the 7, and hears a correct-answer sound effect when he lifts his scanning apparatus. 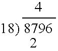
9) Johnny tries to continue to multiply 4×18 in his head, but realizes he needs help. He writes down 4×18 on another spot on the paper: 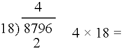
He scans the blank paper to the right of the equal sign. His scanning apparatus announces:
“4 times 18 equals 4 times 10 plus 4 times 8. So 40 plus 32 equals (answer sound effects) 72.”
10) Johnny writes a 7 under the 8, then subtracts 72 from the 87. 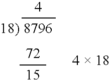
11) Johnny isn't sure what to do next, so he scans the division scaffold again and hears:
“Bring down the 9 from 879 to make 159.”
12) Johnny writes down the 9 and realizes his next step is to divide 18 into 159. He thinks that 18 goes into 159 approximately 9 times and he writes 9 next to the 4 in the quotient. 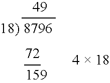
13) The scanning apparatus produces a gentle wrong-answer sound effect. Johnny scans the 9 and hears:
“18 goes into 159 approximately 8 times.”
14) Johnny erases the 9 and writes 8. He hears a correct answer sound effect. Johnny surprises himself with his ability to multiply 18 times 8 in his head (8 times 10 (80) plus 8 times 8 (64) equals 144). He writes 144 under 159 and subtracts, pulling down the 6. 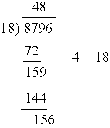
15) Johnny knows that 18 goes into 156 8 times, and writes down 8 in the quotient, next to 48. Then writes down 144 beneath 156, and subtracts. 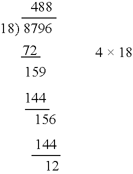
16) Johnny realizes that this is the remainder and writes an R with the remainder 12 next to the quotient 488. When he lifts his scanning apparatus up from the 12, he hears a correct answer sound effects, and then:
“Good Job! 8796 divided by 18 equals 488 remainder 12”

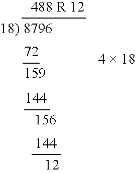

### EXAMPLE 2

Marie, 12, in Paris, uses her scanning apparatus with her junior-high math software module. She works through her exponent problem in a similar interactive, intelligently assisted manner to learn how to multiply: 2⁵×2³. She learns to add the exponents to produce 2⁸, and calculates that to be 256. She than tackles an extra credit problem asking to calculate the value of 9^{-1/2}. She learns that a negative exponent means she takes the reciprocal, l/9^{1/2} and that the fractional exponent ½ means she must take the square root of 9, so the answer is ⅓.

### EXAMPLE 3

Sudo works through his factoring and learns that x²−x−6=0 factors to (x-3)(x+2)=0, and the solution is: x∈{3, −2}. Sudo finishes his homework and puts down his scanning apparatus. His mom enters his room and asks if she can borrow it. She has some forms to fill out. She completes her work, using automatic calculation functions, which are performed more directly with the scanning apparatus than a calculator, and then settles down to play a crossword puzzle. Mom thaws a grid with the scanning apparatus and fills in the squares according to instructions from the scanning apparatus, and begins scanning squares to hear clues and then plays the game.

### EXAMPLE 4

Diet Tracker

A dieter writes down each food item eaten in a small pocket note pad. He is instantly provided with calories, protein, carbohydrates, cumulative calories for the day, remaining calories, etc. This could also assist diabetics. Logged information stored in the scanning apparatus could be uploaded to a server for report generation, health assessment, etc. This application is well suited due to the ease of writing coupled with the audio feedback, offering instant calculation, immediate gratification, and even emotional support with positive voice comments.

### EXAMPLE 5

Musical Composer

An aspiring composer or musical student writes notes on a staff and hears each note as it is written. He writes the sharps/flats for the key, and hears the key announced. He scans the first line of music to hear his composition play. He adds chords and dynamics, and the music adjusts. He selects instruments and commands an orchestral.

### EXAMPLE 6

Games

This system can be used with games for all ages—for play anytime, anywhere, with one or multiple players. The games include crossword puzzles, word games, art/shape thawing games, spelling, mapping, etc.

### EXAMPLE 7

Learning

Any subject involving writing symbols could be used in embodiments of the invention. Examples include: chemistry, physics, electronics-schematic diagrams, geometry, trigonometry, calculus, etc. Any of these can be augmented with intelligent dialog via the scanning apparatus. In addition to pages designed for homework submission, embodiments of the invention can include workbooks with pre-printed print elements that have pages that teach the user about specific subjects.

### EXAMPLE 8

Audio Voice Organizer

The limitation with today's “voice recorders” is that the buckets of recorded voice are difficult to access because they cannot be easily “indexed”. If a user can write a name: “John Smith” and then dictate a note for John, the user can simply write the name “John Smith” again and access his recording.

### EXAMPLE 9

Instant Alarm Clock

Write “10 AM Tues” and an alarm is set. This application features “lightweight” data entry with high yield results. The scanning apparatus would offer the fastest means available to set an alarm.

### EXAMPLE 10

Tax Assistant

A taxpayer filling out a tax form requires clarification on a line item. This user scans the line and receives immediate audio assistance. The user, enters values, and receives notes if values are out of range or are misplaced. Boxes can be automatically calculated or checked for accuracy.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

All references, patent applications, and patents mentioned above are herein incorporated by reference in theft entirety for all purposes. None of them are admitted to be prior art to the presently claimed inventions.

What is claimed is:

1. An interactive system comprising:
a scanning apparatus comprising (i) a stylus having an optical detector, (ii) a processor coupled to the optical detector and the optical emitter, (iii) a memory unit comprising code for different audio outputs corresponding to a plurality of print elements on a surface and code for determining locations on the surface, the memory unit coupled to the processor, and (iv) an audio output device coupled to the processor, wherein the scanning apparatus recognizes at least one of the plurality of print elements on a surface via the code for determining locations, and provides an audio output in accordance with the one print element.

2. The interactive system of claim 1 wherein the surface is a sheet of paper or a molded plastic body.

3. The interactive system of claim 1 wherein the stylus further comprises a writing element.

4. The interactive system of claim 1 wherein the processor, the memory unit, and the audio output device are in the stylus.

5. The interactive system of claim 1 further comprising a platform and wherein the processor, the memory unit, and the audio output device are in the platform.

6. The interactive system of claim 1 wherein the surface is a globe.

7. The interactive system of claim 1 wherein the plurality of print elements includes words and the different audio outputs comprise spelling or sounding words.

8. The interactive system of claim 1 wherein the surface has a plurality of positions and the plurality of print elements are respectively at the plurality of positions, and a plurality of substantially invisible codes respectively are at the plurality of positions and associated with the plurality of positions on the surface, and wherein the plurality of codes comprise a plurality of dots that represent binary codes.

9. The interactive system of claim 1 wherein the different audio outputs comprise different music outputs associated with the print elements.

10. The interactive system of claim 1 wherein the different audio outputs comprise instructions for learning math.

11. A scanning apparatus for use with an article comprising (i) a surface having a plurality of positions and a plurality of different print elements respectively at the plurality of positions, and (ii) a plurality of substantially invisible codes respectively at the plurality of positions and associated with the plurality of positions on the surface, the scanning apparatus comprising:
a stylus comprising an optical detector;
a processor coupled to the optical detector;
a memory unit comprising code for different audio outputs corresponding to the different print elements and code for correlating the locations of the plurality of positions with the audio outputs, the memory unit coupled to the processor; and
an audio output device coupled to the processor.

12. The scanning apparatus of claim 11 wherein the article comprises a sticker.

13. The scanning apparatus of claim 11 wherein the processor, memory unit, and the audio output device are in the stylus.

14. The scanning apparatus of claim 11 wherein the different audio outputs comprise the sounds of words, the spelling of words, or music.

15. The scanning apparatus of claim 11 further comprising a transceiver coupled to the processor.

16. The scanning apparatus of claim 11 wherein the memory unit further comprises code for rendering audible questions, code for playing games, code for recording audio provided by the user, code for user entered data, and/or code for recognizing handwriting or printed characters.

17. A scanning apparatus for use with an article comprising a surface having a plurality of positions and a plurality of print elements respectively at the plurality of positions and a plurality of substantially invisible codes at the plurality of positions, wherein the codes relate to locations for the positions, wherein the substantially invisible codes are free of audio data, and wherein the scanning apparatus in the form of a stylus, the scanning apparatus comprising:
an optical detector;
a processor coupled to the optical detector;
a memory unit storing code for different audio outputs corresponding to the print elements, the memory unit coupled to the processor; and
an audio output device coupled to the processor.

18. A method for generating an audio output in response to scanning, the method comprising:
determining a first location of a first print element on a surface and correlating the first location to the first print element;
producing a first audio output corresponding to the first print element;
determining a second location of a second print element on the surface and correlating the second location to the second print element; and
producing a second audio output corresponding to the second print element, wherein the second audio output is different than the first audio output.

19. The method of claim 18 wherein the first and second audio outputs comprise math instruction.

20. The method of claim 18 wherein the first and second audio outputs are produced by a scanning apparatus comprising a writing element.

21. The method of claim 18 wherein the first and second audio outputs are produced by a scanning apparatus comprising a speaker.

22. A method for scanning, the method comprising:
determining a location of a print element on a surface and correlating the location to the print element, the print element created by a writing element in a scanning apparatus; and
generating an audio output corresponding to the print element, the audio output generated by the scanning apparatus.

23. The method of claim 22 wherein the surface is a sheet of paper.

24. The method of claim 22 wherein the audio output is related to a mathematical computation defined by the print element.

25. An interactive system comprising:
a scanning apparatus comprising (i) a stylus having an optical detector, (ii) a processor coupled to the optical detector, (iii) a memory unit storing code for audio outputs and code for storing locations of a plurality of positions of a surface, the memory unit coupled to the processor, and (iv) an audio output device coupled to the processor, wherein the surface has a plurality of positions and a plurality of substantially invisible codes respectively at the plurality of positions and associated with the plurality of positions on the surface, wherein the substantially invisible codes are free of audio data.

26. The system of claim 25 wherein the surface comprises a sheet of paper.

27. The system of claim 25 wherein the processor, the memory unit, and the audio output device are in the stylus.

28. An interactive system comprising:
a scanning apparatus comprising (i) a stylus having an optical detector, (ii) a processor coupled to the optical detector, (iii) a memory unit coupled to the processor, wherein the memory unit comprises code for an output dependent on the scanning of a first substantially invisible code and a second substantially invisible code, and (iv) an audio output device coupled to the processor, wherein the first substantially invisible code comprises at least one sticker and a first print element, and the second substantially invisible code comprises a second print element, wherein the at least one sticker is on an object.

29. The interactive system of claim 28 wherein the first print element is on a first sticker and the second print clement is on a second sticker.

30. The interactive system of claim 28 wherein the output relates to numbers.

31. The interactive system of claim 28 wherein the first and second print elements are letters.

32. A method comprising:
(a) scanning a first substantially invisible first code of an article including at least one sticker comprising the first substantially invisible code and a first print element and a second substantially invisible code and a second print element;
(b) scanning the second substantially invisible code; and
(d) generating audio relating to the first print element and the second print element.

33. The method of claim 32 wherein the first and second codes are in the form of dot patterns.

34. The method of claim 32 wherein the first and second print elements are letters.

35. The method of claim 32 wherein the first and second print elements are on first and second stickers.

36. The method of claim 32 wherein the first and second print elements are numbers.
